(19) United States
(12) Patent Application Publication
(10) Pub. No.: US 2025/0254097 A1
(43) Pub. Date: Aug. 7, 2025

(54) METHOD, APPARATUS, DEVICE, AND READABLE MEDIUM FOR NETWORK SIMULATION

(71) Applicants: Lemon Inc., Grand Cayman (KY); Beijing Zitiao Network Technology Co., Ltd., Beijing (CN)

(72) Inventors: Zhaoyu Gao, Los Angeles, CA (US); Weirong Jiang, Los Angeles, CA (US); Anubhavnidhi Abhashkumar, Los Angeles, CA (US); Yi Wang, Los Angeles, CA (US); Jian Wang, Beijing (CN)

(21) Appl. No.: 19/041,974

(22) Filed: Jan. 30, 2025

(30) Foreign Application Priority Data
Feb. 7, 2024 (CN) 202410172912.0

(51) Int. Cl. H04L 41/14

(52) U.S. Cl. CPC H04L 41/145

(57) ABSTRACT

Embodiments of the disclosure provide a method, an apparatus, a device, and a readable medium for network simulation. The method includes: running a simulation network corresponding to a backbone network and a data center network in a simulation test environment, where the simulation network includes simulation nodes corresponding to a full set of devices in the backbone network and simulation nodes corresponding to a part of devices in the data center network, and the part of devices include a full set of core devices in a core-level network of the data center network and a part of basic devices sampled from a basic-level network; receiving a test request for the data center network, where the test request includes change command for one or more devices; adjusting the simulation network based on the test request; and performing network simulation on the adjusted simulation network in the network simulation environment.

### CROSS REFERENCE

The application claims priority to Chinese Patent Application No. 202410172912.0, filed on Feb. 7, 2024, and entitled “METHOD, APPARATUS, DEVICE, AND READABLE MEDIUM FOR NETWORK SIMULATION”, the entirety of which is incorporated herein by reference.

### FIELD

Example embodiments of the present disclosure generally relate to the field of computers, and in particular, to a method, an apparatus, a device, and a computer-readable storage medium for network simulation

### BACKGROUND

In order to ensure the reliability and security of a data center network, before certain changes are performed on the data center network, network simulation is usually performed in a simulation environment. The network simulation is mainly used to verify the configuration of a network device and assess potential risks posed by configuration changes to the production network. Since the simulation environment is completely isolated from the production network, a user can perform any operation on a simulation device in the simulation environment without affecting the production network.

### SUMMARY

In a first aspect of the present disclosure, a method for network simulation is provided. The method includes: running a simulation network corresponding to a backbone network and a data center network in a simulation test environment, where the simulation network includes simulation nodes corresponding to a full set of devices in the backbone network and simulation nodes corresponding to a part of devices in the data center network, and the part of devices include a full set of core devices in a core-level network of the data center network and a part of basic devices sampled from a basic-level network; receiving a test request for the data center network, where the test request includes at least one change command for one or more devices; adjusting the simulation network based on the test request; and performing network simulation on the adjusted simulation network in the network simulation environment.

In a second aspect of the present disclosure, an apparatus for network simulation is provided. The apparatus includes: a simulation network running module configured to run a simulation network corresponding to a backbone network and a data center network in a simulation test environment, where the simulation network includes simulation nodes corresponding to a full set of devices in the backbone network and simulation nodes corresponding to a part of devices in the data center network, and the part of devices include a full set of core devices in a core-level network of the data center network and a part of basic devices sampled from a basic-level network; a test request receiving module configured to receive a test request for the data center network, where the test request includes at least one change command for one or more devices; a simulation network adjusting module configured to adjust the simulation network based on the test request; and a simulation network performing module configured to perform network simulation on the adjusted simulation network in the network simulation environment.

In a third aspect of the present disclosure, an electronic device is provided. The electronic device includes at least one processing unit; and at least one memory coupled to the at least one processing unit and storing instructions executable by the at least one processing unit, where the instructions, when executed by the at least one processing unit, cause the electronic device to perform the method according to the first aspect of the present disclosure.

In a fourth aspect of the present disclosure, a computer-readable storage medium is provided. A computer program is stored on the computer-readable storage medium, and the computer program is executable by a processor to perform the method according to the first aspect of the present disclosure.

It should be understood that the content described in the Summary section is not intended to identify key features or essential features of the embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages and aspects of various implementations of the present disclosure will become more apparent hereinafter, with reference to the drawings and following detailed description. In the drawings, the same or similar reference numerals denote the same or similar elements, where:

FIG. 1 illustrates a schematic diagram of an example environment in which embodiments of the present disclosure can be implemented;

FIG. 2 illustrates a schematic diagram of an example data center network according to some embodiments of the present disclosure;

FIG. 3 illustrates a flowchart of a process for network simulation according to some embodiments of the present disclosure;

FIG. 4 illustrates an example diagram illustrating the relationship between the number of cross-physical machine links and operating overheads under different bridges according to some embodiments of the present disclosure;

FIG. 5 illustrates an example diagram of performing network changes in simulation networks running in parallel according to some embodiments of the present disclosure;

FIG. 6 illustrates a block diagram of an apparatus for network simulation according to some embodiments of the present disclosure; and

FIG. 7 illustrates a block diagram of an electronic device in which one or more embodiments of the present disclosure can be implemented.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as being limited to the embodiments set forth herein. On the contrary, these embodiments are provided for a more thorough and complete understanding of the present disclosure. It should be understood that the drawings and the embodiments of the present disclosure are only for illustrative purposes, and are not intended to limit the protection scope of the present disclosure.

In the description of the embodiments of the present disclosure, the term “comprise/include” and similar terms should be understood as open inclusion, that is, “comprise/include but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

In this article, unless explicitly stated, performing a step “in response to A” does not mean that the step is performed immediately after “A”, but may include one or more intermediate steps.

It can be understood that data involved in the technical solution (including but not limited to the data itself, the acquisition, use, storage or deletion of the data) should comply with the requirements of corresponding laws and regulations and relevant provisions.

It can be understood that before using the technical solutions disclosed in the embodiments of the present disclosure, relevant users should be informed of the type, scope of use, use scenarios, etc. of the information involved in the present disclosure in an appropriate manner in accordance with relevant laws and regulations, and the authorization of the relevant users should be obtained. The relevant users may include any type of rights subject, such as an individual, an enterprise, or a group.

For example, in response to receiving an active request from a user, prompt information is sent to the relevant user to explicitly prompt the relevant user that the operation requested to be performed will require the acquisition and use of the information of the relevant user, so that the relevant user can independently select whether to provide the information to the software or hardware such as an electronic device, an application, a server, or a storage medium that performs the operation of the technical solution of the present disclosure according to the prompt information.

As an optional but non-limiting implementation, the method of sending prompt information to the relevant user in response to receiving the active request from the relevant user may be, for example, a pop-up window, and the prompt information may be presented in text in the pop-up window. In addition, the pop-up window may also carry a selection control for the user to select “agree” or “disagree” to provide information to the electronic device.

It can be understood that the above process of notifying and obtaining the authorization of users is only illustrative, and does not limit the implementations of the present disclosure. Other methods that meet relevant laws and regulations may also be applied to the implementations of the present disclosure. The enabling of digital assistant-related functions, the acquisition of data, the processing and storage of data, etc. in the embodiments of the present disclosure should obtain the advance authorization of the user and other rights subjects associated with the user, and should comply with the agreements of relevant laws and regulations and the protocol rules between rights subjects.

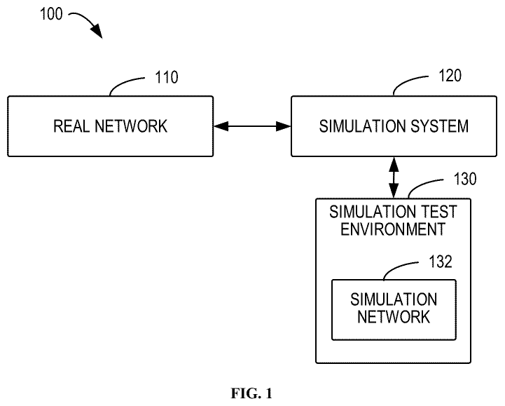

FIG. 1 illustrates a schematic diagram of an example environment 100 in which embodiments of the present disclosure can be implemented. In the environment 100, a simulation system 120 is configured to support simulation operations for one or more real networks 110. The simulation system 120 can construct a simulation network 132 corresponding to the real network 110 in a simulation test environment 130. The simulation network 132 runs in the simulation test environment 130 to perform simulation tests for the real network 110 as required.

The simulation system 120 and/or the simulation test environment 130 can be any type of device with computing power, including a terminal device or a server-side device. The terminal device can be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, or any combination of the foregoing, including accessories and peripherals of these devices or any combination thereof.

The server-side device can include, for example, a computing system/server, such as a mainframe, an edge computing node, a computing device in a cloud environment, etc. The server-side device can be an independent physical server, or a server cluster or distributed system composed of multiple physical servers, or a cloud server that provides basic cloud computing services such as cloud services, cloud databases, cloud computing, cloud functions, cloud storage, network services, cloud communication, middleware services, domain name services, security services, content distribution networks, and big data and artificial intelligence platforms. The server-side device can include, for example, a computing system/server, such as a mainframe, an edge computing node, a computing device in a cloud environment, etc. In some embodiments, the simulation system 120 and/or the simulation test environment 130 can be implemented based on cloud services.

It should be understood that the structure and function of the environment 100 are described for illustrative purposes only, without implying any limitation to the scope of the present disclosure.

For a data center network, the main work of network simulation is to create, for a user (e.g., a network engineer), a simulation environment replicating the data center network through virtualization technology, according to the network change requirements of the user, so that the user can verify the changes to the data center network in advance in the simulation environment. Since the simulation environment is completely isolated from the production network corresponding to the data center, the user can perform any operation on the simulation device in the simulation environment without affecting the production network.

Traditional network simulation requires full network simulation for the network to be simulated to ensure network stability and security. However, for a large-scale network, such as many data center networks, the number of devices is huge and the network topology connections are complex, so the construction complexity and simulation computing overhead of the full network simulation are very large.

Some traditional simulation systems are not suitable for the construction of a large-scale network simulation environment due to the lack of means for automated construction of a virtual environment. Some systems for creating simulation environments for large network topologies have also been developed at present. However, these systems still have drawbacks. For example, the safe boundary search algorithm proposed in some solutions is not applicable to all data center networks. In actual production, it has been found that several previous network accidents caused by changes failed to find a static safe boundary through this algorithm.

A data center network constructed based on some standard topology design solutions (e.g., a Clos topology) has its own characteristics. Specifically, the configurations of low-level devices in many data center networks are generated based on standardized designs, while high-level core devices may not be guaranteed with similar standardized topologies and configurations.

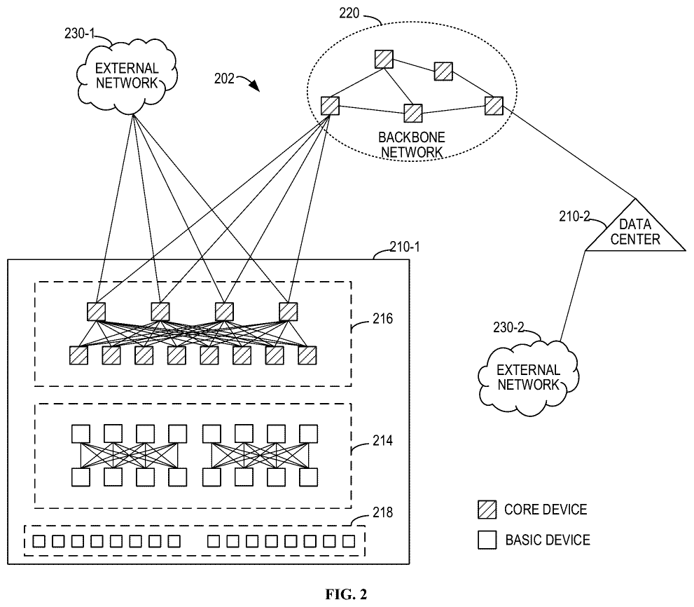

FIG. 2 illustrates a schematic diagram of an example network according to some embodiments of the present disclosure. As shown in FIG. 2, a data center network 202 includes one or more data centers (DC) 210-1, 210-2 (collectively or individually referred to as data centers 210). The data centers 210 may be connected to each other through a backbone network 220. In addition, the data centers 210 may also be connected to networks outside the data center network, which are referred to as external networks 230-1, 230-2 (collectively or individually referred to as external networks 230). The external networks 230 may include, for example, cloud networks, the Internet, etc.

Each data center 210 includes multiple devices, such as storage devices, service devices, switches, various networking devices, etc., to support the operation of the data center. The types and number of devices in the data center network are not limited in the embodiments of the present disclosure. FIG. 2 illustrates an example internal structure of the data center 210-1. The core network 220 also includes multiple devices that are interconnected and connected to one or more devices of the data centers 210. In the backbone network 220 and the data center network 202, the multiple devices are also connected to each other to form a network topology.

The data center 210 may include multiple devices interconnected inside, and may also include devices responsible for the external connection of the data center 210. As shown in FIG. 2, in the data center 210-1, the devices in the device group 216 may be connected to the external network 230-1 and the backbone network 220 of the data center network. In addition, the data center 210-1 also includes the underlying device groups 214 and 218, etc.

In some embodiments, the devices in the data center 210 that are connected to the external network may be referred to as core devices, and the devices in the backbone network are also referred to as core devices or backbone network devices. Inside the data center 210, the devices that are not directly connected to the external network are referred to as basic devices. Therefore, in FIG. 2, in the data center network 202, the basic devices inside each data center 210 form a basic-level network (e.g., including the device groups 214 and 218 in the data center 210), and the devices in each data center 210 that are connected to the external network and the devices in the backbone network form a core-level network of the data center network 202 (e.g., including the device group 216 inside the data center 21 and the devices in the backbone network 220).

In FIG. 2, the real network to be simulated includes the data center network 202 (i.e., each data center) and the backbone network for connecting the data centers.

As previously described, it is observed that the configurations of the low-level devices in the data center network are generated based on standardized designs and conform to a unified specification, while high-level core devices may not be guaranteed with similar standardized topologies and configurations.

Based on this observation, in an embodiment of the present disclosure, it is proposed to sample a part of networks from the standardized low-level data center network (e.g., select representative devices) to achieve the same purpose as the full network simulation, which can not only trigger the full aggregation route, but also receive route changes triggered by other devices. For high-level core devices in the data center network, it is usually difficult to guarantee similar standardized topologies and configurations. For example, for topologies, some connections between data centers (inter-DC) require a global backbone network, while some rely on direct dedicated lines. On the other hand, since high-level devices need to establish connections with different network operators and cloud vendors, and these vendors often adopt different connection establishment methods, it is also difficult to standardize the configurations of high-level devices from a practical point of view.

Based on the above observations, in an embodiment of the present disclosure, it is proposed to construct a simulation network to include all devices in a backbone network and all high-level core devices and low-level sampled devices in a data center network. In this way, the security of network changes can be ensured, that is, potential risks of a network change on the entire network can be found in time during the network simulation process. Meanwhile, the simulation network can also trigger all existing network routes on the high-level core devices to achieve the maximum authenticity that can be achieved by the network simulation.

Some example embodiments of the present disclosure will be described below with continued reference to the drawings.

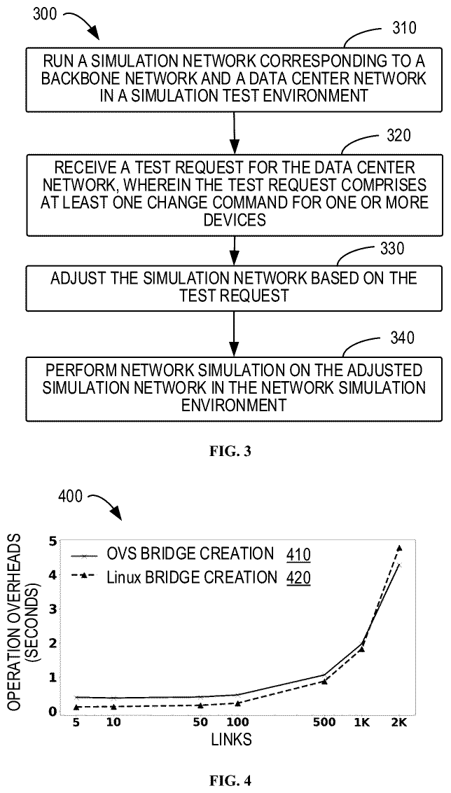

FIG. 3 illustrates a flowchart of a process 300 for network simulation according to some embodiments of the present disclosure. The process 300 may be implemented in the simulation system 120 of FIG. 1. For ease of discussion, the process 300 will be described with reference to the environment 100 of FIG. 1 and the example data center of FIG. 2.

At block 310, the simulation system 120 runs a simulation network corresponding to the backbone network 220 and the data center network 202 in the simulation test environment 130, where the simulation network includes simulation nodes corresponding to a full set of devices in the backbone network 220 and simulation nodes corresponding to a part of devices in the data center network 202. The part of devices in the data center network 202 include a full set of core devices in a core-level network of the data center network 202, a part of basic devices sampled from a basic-level network, and an overall core device in the core-level network.

In some embodiments, the basic devices in the basic-level network of the data center network 202 conform to a unified specification. In some embodiments, the core devices in the backbone network 220 and the core-level network of the data center network 202 may follow different specifications, which are not limited here. In order to aggregate the functions of the core network and reduce the scale of the simulation network as much as possible, in the embodiments of the present disclosure, for devices conforming to the unified specification (e.g., devices in the basic-level network), network simulation is performed through sampling instead of full simulation. In this way, in a large-scale simulation test environment, the simulation network corresponding to the backbone network 220 and the data center network 202 can include all core devices in the existing network and selected low-level non-core devices, so that all aggregation routes of the core devices can be triggered. In some embodiments, the simulation network is also referred to as a regression test bed.

In some embodiments, the simulation system 120 can create the simulation network by: for each device of the part of devices in the data center network 202, encapsulating at least a virtual machine image with a virtual machine management program (hypervisor) in the simulation test environment 130 to form a container image; and generating, based on the container image, a simulation node corresponding to the device. The device includes a part of basic devices sampled from the basic-level network of the data center network 202 and an overall core device in the core-level network. For the encapsulation object, in addition to including at least the virtual machine image and the virtual machine management program, a software library related to the two may also be included, that is, the virtual machine image, the virtual machine management program, and the related software library are packaged together into a container image, and each container image has a corresponding simulation node. In addition, the virtual machine network interface inside the container and the network interface of the external container implement interworking through MacVTap (a network virtualization interface), and implement a one-to-one mapping between the virtual machine network interface and the external container network interface.

The simulation node corresponding to each device is generated based on the container image, which is convenient for managing all simulation nodes in the simulation network 120. If multiple imaging methods are used to generate simulation nodes in the simulation network, when creating, destroying, adding, or reducing simulation nodes, the simulation nodes generated by different imaging methods have different access or exit methods when accessing or exiting the simulation network, which makes it difficult for the simulation network to manage the simulation nodes.

Alternatively, or additionally, in some embodiments, the simulation network may also be created by: for each device of the some devices in the data center network 202, generating individually, based on the virtual machine image, the simulation node corresponding to the device in the simulation test environment 130.

In some embodiments, the simulation system 120 can create the simulation network by: for the part of devices in the data center network 202, connecting simulation nodes on a same physical machine through a virtual Ethernet (veth) module in the simulation network; and connecting simulation nodes on different physical machines via the network tunnel between the physical machines in the simulation network, where the network tunnel is established through the bridge. The network tunnel may be, for example, a VXLAN (Virtual eXtensible Local Area Network). The bridge may be, for example, an OVS bridge, a Linux bridge, etc.

Specifically, in the simulation test environment 130, each simulation node corresponds to a container (or a virtual machine), and multiple virtual machines or containers may be distributed on the same physical machine or on different physical machines. For the case where multiple virtual machines or containers may be distributed on the same physical machine, the simulation nodes may be directly connected through virtual Ethernet module ports. For the case where multiple virtual machines or containers may be distributed on different physical machines (i.e., across physical machines), virtual machines across physical machines need to be connected through the network tunnel. For example, in the case of cross physical machines, the simulation nodes are connected via an OVS bridge and then via a VXLAN tunnel. The management port (mgmt) is bridged to a bridge (Linux bridge) by default to facilitate user login and use.

Generally, the creation of too many cross-physical machine tunnels may lead to serious performance degradation. The more cross-physical machine tunnels are created, the longer it takes to create each new tunnel. FIG. 4 illustrates an example diagram illustrating the relationship between the number of cross-physical machine links and operating overheads under different bridges according to some embodiments of the present disclosure. As shown in FIG. 4, for the relationship diagram 400, as the number of links increases, the operating overheads of OVS bridge creation 410 and Linux bridge creation 420 gradually increase, especially when the number of links increases to a certain number (such as 1K), the operating overheads of both increase sharply. Therefore, as the number of cross-physical machine tunnels created increases, the creation time of each new tunnel becomes longer, which in turn leads to serious performance degradation of the simulation test environment 130.

Therefore, the number of cross-physical machine tunnels (cross-physical machine links) is reduced. In some embodiments, a graph partitioning algorithm in a simulation topology is proposed to reduce cross-physical machine links. The simulation system 120 may also create the simulation network by: for the part of devices in the data center network 202, constructing a target diagram corresponding to the individual simulation nodes in the simulation network; partitioning the target diagram into a plurality of partitions by applying the graph partition algorithm to the target diagram, where each partition of the plurality of partitions includes a set of simulation nodes; and deploying a set of simulation nodes corresponding to each partition of the plurality of partitions into a same physical machine. In some embodiments, a goal of the graph partitioning is to make the cross-physical machine links as few as possible after partitioning.

In order to apply the graph partition algorithm, graph modeling is performed first. Assuming that a graph G=(V,E), weight: E→ [symbol] is given, where V is a set of simulation nodes, E is edges between simulation nodes, and weight(e) is the number links between nodes connected by the edges e. Given positive integers n,k (n is the number of partitions, and k is the capacity limit of the physical machine), the graph partition problem is to partition the graph V into n disjoint sets (i.e., n partitions) V₁, V₂, . . . , Vₙ, and to satisfy: V=V₁∪V₂∪ . . . Vₙ, max(|V₁|, |V₂|, . . . |Vₙ|)≤k, and Σ_{i,j}, Σ_{e∈E}_{ᵢⱼ} weight(e) is as few as possible, and Eᵢⱼ=E∩Vᵢ×Vⱼ is a set of edges between two sets Vᵢ and Vⱼ. By applying the graph partition algorithm, it is possible to quickly and accurately determine which simulation nodes are to be divided into the same physical machine, while minimizing the need to create physical machine links.

After the simulation network of the data center 110 is created, the simulation network can be run in the simulation test environment 130 to support network simulation for the data center network 202.

Referring back to FIG. 3, at block 320, the simulation system 120 receives a test request for the data center network 202, where the test request includes at least one change command for one or more devices. The one or more devices may be, for example, one or more basic devices, and/or one or more core devices, depending on specific test requirements. At block 330, the simulation system 120 adjusts the simulation network based on the test request. At block 340, the simulation system 120 performs network simulation on the adjusted simulation network in the network simulation environment.

In some embodiments, for the test request, the simulation system 120 needs to determine whether there are simulation nodes corresponding to the one or more devices in the simulation network. If the one or more devices to be tested in the test request have been included in the simulation network, that is, if the simulation nodes corresponding to these devices can be found in the simulation network, the change commands can be directly applied in the simulation network. The change commands can be configured according to specific simulation needs. If it is determined that at least one of the one or more devices does not have a corresponding simulation node in the simulation network, the simulation system 120 will add the simulation node corresponding to the at least one device in the simulation network. In some embodiments, if the addition of at least one of the one or more devices is detected in the simulation network, a route aggregation operation of the overall core device in the core-level network can be triggered. In addition, one or more network change work orders may specify one or more network devices and the corresponding change commands, and if these devices have been included in the simulation network, the change commands may be directly applied for testing. Therefore, the simulation network can be adjusted in this way to enable dynamic access of the changed device to the simulation network.

In some embodiments, a plurality of copies of the simulation network corresponding to the data center network 202 may also be run in the simulation test environment 130. In this way, if a plurality of test requests for the data center network 202 are received, the simulation system 120 can perform network simulation corresponding to the plurality of test requests in parallel in the plurality of copies of the simulation network, which can support simultaneous access for different tests.

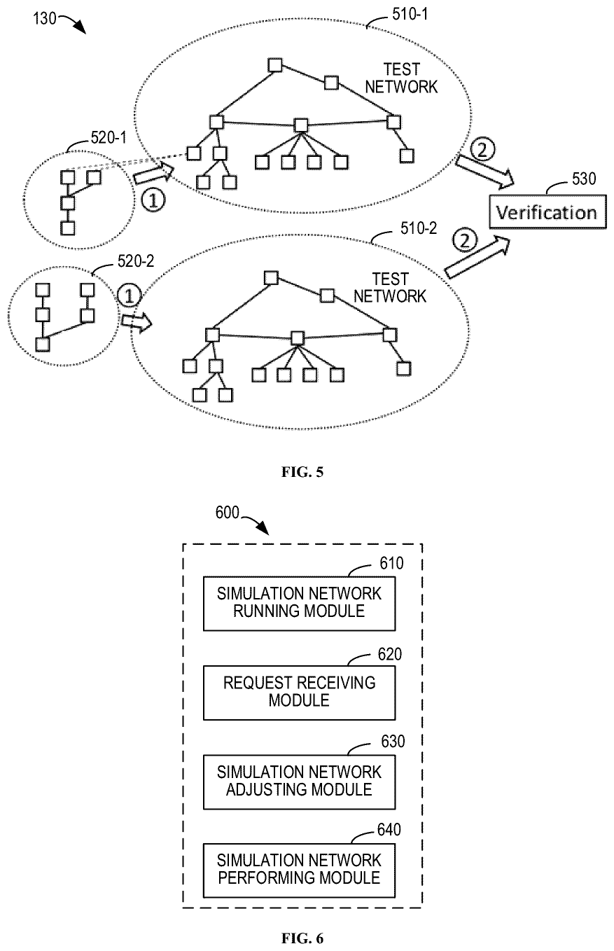

FIG. 5 illustrates an example diagram of performing network changes in simulation networks running in parallel according to some embodiments of the present disclosure. As shown in FIG. 5, for the process 130, there are a first copy 510-1 and a second copy 510-2 of the simulation network. While the first copy 510-1 performs network simulation for a first set of devices 520-1 corresponding to a first test request, the second copy 510-2 may perform network simulation for a second set of devices 520-2 corresponding to a second test request, and so on. After the network simulation of the two test requests is completed, the verification may be performed separately in the verification module 530 for different test requests to confirm the correctness of the test results. By providing multiple sets of simulation networks, the efficiency of network simulation can be improved. In addition, it is precisely because the simulation network is not a full simulation of a large-scale data center network, the embodiments of the present disclosure can support the simultaneous running of the plurality of copies in the simulation test environment.

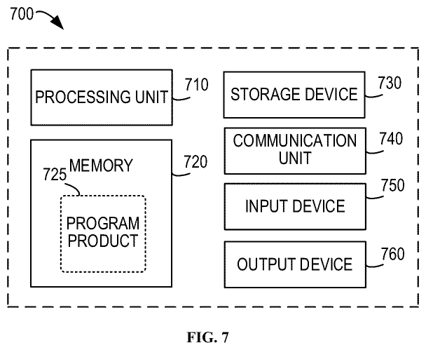

The embodiments of the present disclosure further provide corresponding apparatuses for implementing the above method or process. FIG. 6 illustrates a block diagram of an apparatus 600 for network simulation according to certain embodiments of the present disclosure. The apparatus 600 may be implemented as or included in the simulation system 120. The modules/components in the apparatus 600 may be implemented by hardware, software, firmware, or any combination thereof.

As shown in FIG. 6, the apparatus 600 includes a simulation network running module 610 configured to run a simulation network corresponding to a backbone network and a data center network in a simulation test environment, where the simulation network includes simulation nodes corresponding to a full set of devices in the backbone network and simulation nodes corresponding to a part of devices in the data center network, and the part of devices include a full set of core devices in a core-level network of the data center network and a part of basic devices sampled from a basic-level network. The apparatus 600 also includes a test request receiving module 620 configured to receive a test request for the data center network, where the test request includes at least one change command for one or more devices.

The apparatus 600 also includes a simulation network adjusting module 630 configured to adjust the simulation network based on the test request. The apparatus 600 also includes a simulation network performing module 640 configured to perform network simulation on the adjusted simulation network in the network simulation environment.

In some embodiments, the apparatus 600 also includes a first simulation network creating module configured to create the simulation network by: for each device of the part of devices in the data center network, encapsulating at least a virtual machine image with a virtual machine management program in the simulation test environment to form a container image; and generating, based on the container image, a simulation node corresponding to the device.

In some embodiments, the apparatus 600 further includes a second simulation network creating module configured to create the simulation network by: for each device of the part of devices in the data center network, generating individually, based on the virtual machine image, the simulation node corresponding to the device in the simulation test environment.

In some embodiments, the apparatus 600 further includes a third simulation network creating module configured to create the simulation network by: for the part of devices in the data center network, constructing the target diagram corresponding to the individual simulation nodes in the simulation network; partitioning the target diagram into the plurality of partitions by applying the graph partition algorithm to the target diagram, where each partition of the plurality of partitions includes a set of simulation nodes; and deploying the set of simulation nodes corresponding to each partition of the plurality of partitions into the same physical machine.

In some embodiments, the apparatus 600 further includes a third simulation network creating module configured to create the simulation network by: for the part of devices in the data center network, connecting the simulation nodes on the same physical machine through a virtual Ethernet module in the simulation network; and connecting the simulation nodes on different physical machines via a network tunnel between the physical machines in the simulation network, where the network tunnel is established through the bridge.

In some embodiments, the simulation network adjusting module includes: a node determining module configured to determine whether there are the simulation nodes corresponding to the one or more devices in the simulation network; and a node adding module configured to, if it is determined that there is no simulation node corresponding to the at least one of the one or more devices in the simulation network, add the simulation node corresponding to the at least one device in the simulation network.

In some embodiments, the simulation network running module 610 is configured to run a plurality of copies of the simulation network corresponding to the data center network in the simulation test environment. In some embodiments, the apparatus 600 further includes a copy performing module configured to, in response to receiving a plurality of test requests for the data center network, perform network simulation corresponding to the plurality of test requests in the plurality of copies of the simulation network, respectively.

In some embodiments, the devices in the basic-level network of the data center network conform to a unified specification.

The units and/or modules included in the apparatus 600 may be implemented in various ways, including software, hardware, firmware, or any combination thereof. In some embodiments, one or more units and/or modules may be implemented using software and/or firmware, such as machine-executable instructions stored on a storage medium. In addition to or as an alternative to the machine-executable instructions, some or all of the units and/or modules in the apparatus 600 may be implemented, at least in part, by one or more hardware logic components. By way of example and not limitation, example types of hardware logic components that can be used include a field programmable gate array (FPGA), an application specific integrated circuit (ASIC), an application specific standard product (ASSP), a system on chip (SOC), a complex programmable logic device (CPLD), and the like.

FIG. 7 illustrates a block diagram of an electronic device 700 in which one or more embodiments of the present disclosure can be implemented. It should be understood that the electronic device 700 shown in FIG. 7 is only illustrative, and should not constitute any limitation to the function and scope of the embodiments described herein. The electronic device 700 shown in FIG. 7 may be used to implement the simulation system 110 of FIG. 1 or the apparatus 600 of FIG. 6.

As shown in FIG. 7, the electronic device 700 is in the form of a general-purpose computing device. The components of the electronic device 700 may include, but are not limited to, one or more processors or processing units 710, a memory 720, a storage device 730, one or more communication units 740, one or more input devices 750, and one or more output devices 760. The processing unit 710 may be a physical or virtual processor and can perform various processes according to a program stored in the memory 720. In a multi-processor system, multiple processing units execute computer-executable instructions in parallel to improve the parallel processing capability of the electronic device 700.

The electronic device 700 generally includes multiple computer storage media. Such media may be any available media accessible by the electronic device 700, including but not limited to volatile and non-volatile media, and removable and non-removable media. The memory 720 may be a volatile memory (e.g., a register, a cache, a random-access memory (RAM)), a non-volatile memory (e.g., a read-only memory (ROM), an electrically erasable programmable read-only memory (EEPROM), a flash memory), or some combination thereof. The storage device 730 may be a removable or non-removable medium, and may include a machine-readable medium, such as a flash drive, a disk, or any other medium, which can be used to store information and/or data and can be accessed within the electronic device 700.

The electronic device 700 may further include additional removable/non-removable, volatile/non-volatile storage media. Although not shown in FIG. 7, a disk drive for reading from or writing to a removable, non-volatile disk (e.g., a “floppy disk”) and an optical disk drive for reading from or writing to a removable, non-volatile optical disk may be provided. In these cases, each drive may be connected to a bus (not shown) by one or more data medium interfaces. The memory 720 may include a computer program product 725 having one or more program modules configured to perform various methods or actions of various embodiments of the present disclosure.

The communication unit 740 implements communication with other electronic devices through a communication medium. Additionally, the functions of the components of the electronic device 700 may be implemented in a single computing cluster or multiple computing machines that can communicate through communication connections. Therefore, the electronic device 700 may operate in a networked environment using logical connections with one or more other servers, network personal computers (PCs), or another network node.

The input device 750 may be one or more input devices, such as a mouse, a keyboard, a trackball, etc. The output device 760 may be one or more output devices, such as a display, a speaker, a printer, etc. The electronic device 700 may also communicate with one or more external devices (not shown) through the communication unit 740 as required, the external devices such as storage devices, display devices, etc., communicate with one or more devices that enable the user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to an example implementation of the present disclosure, a computer-readable storage medium is provided, on which computer-executable instructions are stored, where the computer-executable instructions are executed by a processor to implement the method described above. According to an example implementation of the present disclosure, a computer program product is also provided, the computer program product is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, apparatus, device, and computer program product implemented according to the present disclosure. It should be understood that each block of the flowcharts and/or block diagrams and the combination of blocks in the flowcharts and/or block diagrams can be implemented by computer-readable program instructions.

These computer-readable program instructions may be provided to a processing unit of a general-purpose computer, a special-purpose computer, or other programmable data processing apparatus, thereby producing a machine, such that the instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium, and these instructions cause a computer, a programmable data processing apparatus, and/or other devices to work in a specific way, so that the computer-readable medium storing the instructions includes a product, which includes instructions for implementing various aspects of the functions/acts specified in one or more blocks of the flowcharts and/or block diagrams.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions executed on the computer, other programmable data processing apparatus, or other device implement the functions/acts specified in one or more blocks in the flowcharts and/or block diagrams.

The flowcharts and block diagrams in the drawings illustrate the architecture, functionality, and operation of possible implementations of systems, methods, and computer program products according to multiple implementations of the present disclosure. In this regard, each block in the flowcharts or block diagrams may represent a module, a program segment, or a portion of instructions, which includes one or more executable instructions for implementing the specified logical function. In some alternative implementations, the functions noted in the blocks may also occur out of the order noted in the drawings. For example, two consecutive blocks may, in fact, be performed substantially in parallel or in a reverse order, depending upon the functionality involved. It is also noted that each block of the block diagrams and/or flowcharts and combinations of blocks in the block diagrams and/or flowcharts may be implemented by a dedicated hardware-based system that performs the specified functions or acts or a combination of dedicated hardware and computer instructions.

Various implementations of the present disclosure have been described above, and the above description is illustrative, not exhaustive, and is not limited to the disclosed implementations. Many modifications and changes will be apparent to those skilled in the art without departing from the scope and spirit of the described implementations. The selection of terms used herein is intended to best explain the principles, practical applications, or improvements of the technology in the market of the implementations, or to enable other ordinary skilled in the art to understand the various implementations disclosed herein.

What is claimed is:

1. A method of network simulation, comprising:
running a simulation network corresponding to a backbone network and a data center network in a simulation test environment, wherein the simulation network comprises simulation nodes corresponding to a full set of devices in the backbone network and simulation nodes corresponding to a part of devices in the data center network, and the part of devices comprise a full set of core devices in a core-level network of the data center network and a part of basic devices sampled from a basic-level network;
receiving a test request for the data center network, wherein the test request comprises at least one change command for one or more devices;
adjusting the simulation network based on the test request; and
performing the network simulation on the adjusted simulation network in the network simulation environment.

2. The method according to claim 1, further comprising: creating the simulation network by: for each device of the part of devices in the data center network,
encapsulating at least a virtual machine image with a virtual machine management program in the simulation test environment to form a container image; and
generating, based on the container image, a simulation node corresponding to the device.

3. The method according to claim 1, further comprising: creating the simulation network by: for each device of the part of devices in the data center network,
generating individually, based on a virtual machine image, a simulation node corresponding to the device in the simulation test environment.

4. The method according to claim 1, further comprising: creating the simulation network by: for the part of devices in the data center network,
constructing a target diagram corresponding to individual simulation nodes in the simulation network;
partitioning the target diagram into a plurality of partitions by applying a graph partition algorithm to the target diagram, wherein each partition of the plurality of partitions comprises a set of simulation nodes; and
deploying the set of simulation nodes corresponding to each partition of the plurality of partitions into a same physical machine.

5. The method according to claim 1, further comprising: creating the simulation network by: for the part of devices in the data center network,
connecting the simulation nodes on a same physical machine via a virtual Ethernet module in the simulation network; and
connecting the simulation nodes on different physical machines via a network tunnel between the physical machines in the simulation network, wherein the network tunnel is established via a bridge.

6. The method according to claim 1, wherein adjusting the simulation network based on the test request comprises:
determining whether there is at least one simulation node corresponding to the one or more devices in the simulation network; and
in accordance with a determination that there is no simulation node corresponding to at least one of the one or more devices in the simulation network, adding at least one simulation node corresponding to the at least one device in the simulation network.

7. The method according to claim 1, wherein running the simulation network corresponding to the data center network in the simulation test environment comprises:
running a plurality of copies of the simulation network corresponding to the data center network in the simulation test environment; and
wherein the method further comprises:
in response to receiving the plurality of test requests for the data center network, performing the network simulation corresponding to the plurality of test requests in the plurality of copies of the simulation network, respectively.

8. The method according to claim 1, wherein the devices in the basic-level network of the data center network conform to a unified specification.

9. The method according to claim 1, wherein the core devices comprise the devices in the data center network that are connected to an external network and the devices in the backbone network.

10. The method according to claim 1, wherein the basic devices comprise the devices in the data center network that are not directly connected to an external network.

11. An electronic device, comprising:
at least one processing unit; and
at least one memory coupled to the at least one processing unit and storing instructions executable by the at least one processing unit, wherein the instructions, when executed by the at least one processing unit, cause the electronic device to perform acts comprising:
running a simulation network corresponding to a backbone network and a data center network in a simulation test environment, wherein the simulation network comprises simulation nodes corresponding to a full set of devices in the backbone network and simulation nodes corresponding to a part of devices in the data center network, and the part of devices comprise a full set of core devices in a core-level network of the data center network and a part of basic devices sampled from a basic-level network;
receiving a test request for the data center network, wherein the test request comprises at least one change command for one or more devices;
adjusting the simulation network based on the test request; and
performing the network simulation on the adjusted simulation network in the network simulation environment.

12. The electronic device according to claim 11, the acts further comprise: creating the simulation network by: for each device of the part of devices in the data center network,
encapsulating at least a virtual machine image with a virtual machine management program in the simulation test environment to form a container image; and
generating, based on the container image, a simulation node corresponding to the device.

13. The electronic device according to claim 11, the acts further comprise: creating the simulation network by: for each device of the part of devices in the data center network,
generating individually, based on a virtual machine image, a simulation node corresponding to the device in the simulation test environment.

14. The electronic device according to claim 11, the acts further comprise: creating the simulation network by: for the part of devices in the data center network,
constructing a target diagram corresponding to individual simulation nodes in the simulation network;
partitioning the target diagram into a plurality of partitions by applying a graph partition algorithm to the target diagram, wherein each of the plurality of partitions comprises a set of simulation nodes; and
deploying the set of simulation nodes corresponding to each partition of the plurality of partitions into a same physical machine.

15. The electronic device according to claim 11, the acts further comprise: creating the simulation network by: for the part of devices in the data center network,
connecting the simulation nodes on a same physical machine via a virtual Ethernet module in the simulation network; and
connecting the simulation nodes on different physical machines via a network tunnel between the physical machines in the simulation network, wherein the network tunnel is established via a bridge.

16. The electronic device according to claim 11, wherein adjusting the simulation network based on the test request comprises:
determining whether there is at least one simulation node corresponding to the one or more devices in the simulation network; and
in accordance with a determination that there is no simulation node corresponding to at least one of the one or more devices in the simulation network, adding at least one simulation node corresponding to the at least one device in the simulation network.

17. The electronic device according to claim 11, wherein running the simulation network corresponding to the data center network in the simulation test environment comprises:
running a plurality of copies of the simulation network corresponding to the data center network in the simulation test environment; and
wherein the acts further comprise:
in response to receiving the plurality of test requests for the data center network, performing the network simulation corresponding to the plurality of test requests in the plurality of copies of the simulation network, respectively.

18. The electronic device according to claim 11, wherein the devices in the basic-level network of the data center network conform to a unified specification.

19. The electronic device according to claim 11, wherein the core devices comprise the devices in the data center network that are connected to an external network and the devices in the backbone network.

20. A non-transitory computer-readable storage medium having a computer program stored thereon, wherein the computer program is executable by a processor to implement acts comprising:
running a simulation network corresponding to a backbone network and a data center network in a simulation test environment, wherein the simulation network comprises simulation nodes corresponding to a full set of devices in the backbone network and simulation nodes corresponding to a part of devices in the data center network, and the part of devices comprise a full set of core devices in a core-level network of the data center network and a part of basic devices sampled from a basic-level network;
receiving a test request for the data center network, wherein the test request comprises change commands for one or more devices;
adjusting the simulation network based on the test request; and
performing network simulation on the adjusted simulation network in the network simulation environment.
